(19) United States
(12) Patent Application Publication
(10) Pub. No.: US 2005/0156568 A1
(43) Pub. Date: Jul. 21, 2005

(54) Power supply with AC and DC back-up power

(76) Inventor: Wen Hsiang Yueh, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/747,363

(22) Filed: Dec. 30, 2003

(51) Int. Cl. G06F 9/00

(52) U.S. Cl. 320/128

(57) ABSTRACT

A power supply with AC and DC back-up power has a rectifier, a rechargeable battery, a charger, a detecting circuit, a first DC/DC converter and a DC/AC converter. The rectifier is coupled to the power of the wall-socket for generating a first power. Moreover, the rechargeable battery is charged by the first power through the charger, and the detecting circuit detects a power-supplying condition of the wall-socket. The first DC/DC converter is used to convert a power of either the battery or the first power to a second power, and the DC/AC converter converts a power of the battery into AC power.

### BACKGROUND OF THE INVENTION

1. Field of the Invention

The present invention relates to a power supply with AC and DC back-up power, more specially relates to a source device built in the computer.

2. Description of Related Art

Electronic products are developed to be increasingly powerful and indispensable to human. For example, computers have become a necessity for everyday use.

A computer generally obtains power from a wall-socket through a power supply. The wall-socket may suffer power surges or power failure. Therefore the computer's power supply often uses a UPS system to maintain power for a short period time to perform an emergency measure.

FIG. 1 is a schematic diagram of a prior art power supply with a built-in UPS, which comprises a power supply unit 1a and a back-up power unit 2a. The power supply unit 1a includes an EMI filter 11a, a rectifier 12a and a DC/DC converter 13a, and the back-up power unit 2a includes a charger 21a, a rechargeable battery 22a, a DC/AC converter 23a and a detecting circuit 24a. Furthermore, the power supply unit 1a outputs a DC power converted from an AC power.

Normally, the charger 21a receives electric power from a wall-socket for charging the rechargeable battery 22a, and the detecting circuit 24a generates a failure signal when the wall-socket power fails. Upon receiving the failure signal, the DC/AC converter 23a converts the DC output of the rechargeable battery 22a to AC power and sends the AC power to the rectifier 12a. The AC power is converted again by the rectifier 12a and the supplied to the computer for sustaining the operation of the computer for a while. Alternatively, the DC/AC converter 23a can be replaced by a boost circuit with an output connected to the input of the DC/DC converter 13a.

However, in above-mentioned power supply with built-in UPS, the back-up power unit 2a can supply electrical power to motherboard only during power failure of the wall-socket. The back-up power unit 2a cannot supply electrical power to the computer display and the computer thus cannot operate normally. Moreover, displays also have various specifications for rated power.

The present invention supplies the electrical power, back-up source, DC power and AC power source. Moreover, the present invention solves the problems of the prior art power supply.

### SUMMARY OF THE INVENTION

It is the object of the present invention to a power supply with an AC/DC back-up power unit. The power supply with the AC/DC back-up power unit supplies AC and DC power of frequently used levels to a computer display and peripheral devices requiring AC/DC power during power failure of a wall-socket. The cost for additional adapters is saved.

### BRIEF DESCRIPTION OF THE DRAWINGS

The various objects and advantages of the present invention will be more readily understood from the following detailed description when read in conjunction with the appended drawing, in which:

FIG. 1 is a schematic diagram of a prior art power supply with a built-in UPS;

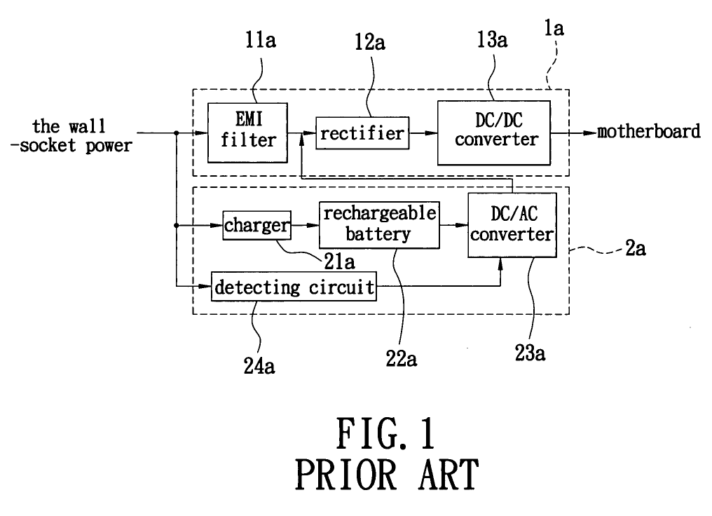

FIG. 2 is a schematic diagram of a circuit of the present of the invention;

FIG. 3 is a schematic diagram of a rectifier of the present of the invention;

FIG. 4 is a perspective view of the present of the invention.

### DETAILED DESCRIPTION OF THE PREFERRED EMBODIMENTS

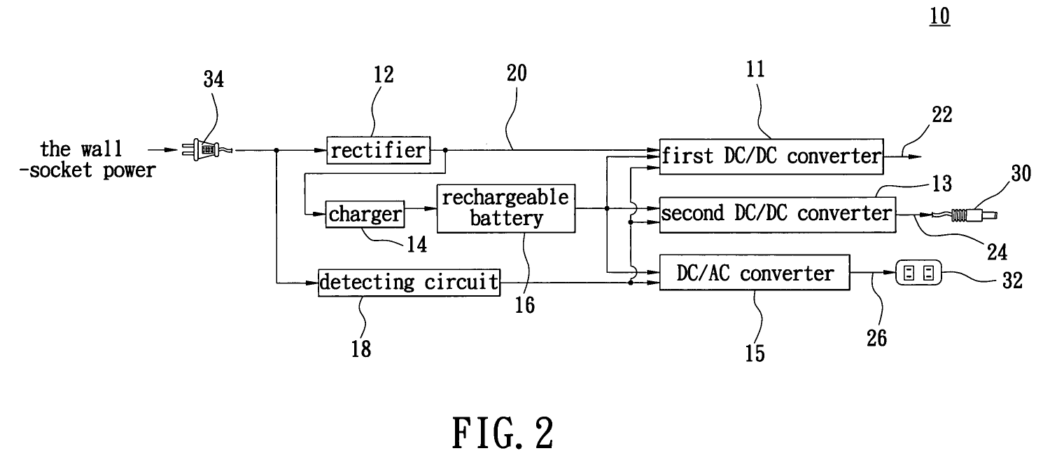

FIG. 2 is a schematic diagram of a circuit of the present of the invention, comprising a rectifier 12, a rechargeable battery 16, a charger 14, a detecting circuit 18, a first DC/DC converter 11 and a DC/AC converter 15.

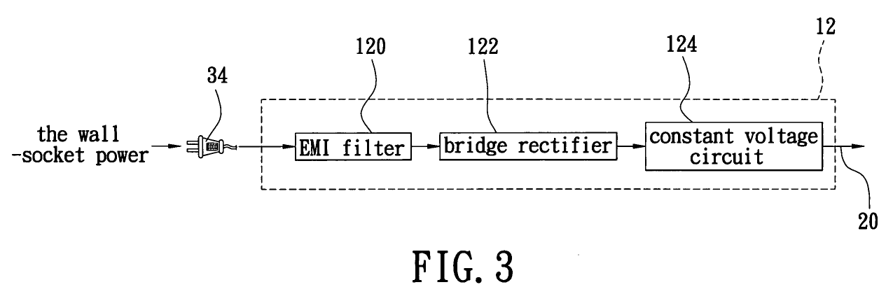

FIG. 3 is a schematic diagram of a rectifier of the present invention The rectifier 12 comprises an EMI filter 120, a bridge rectifier 122 and a constant voltage circuit 124. The EMI filter 120 filters external noise when an AC input port 34 receives electronic power from a wall-socket. Then the high DC power is obtained through the bridge rectifier 122. Moreover, the high DC power is set to be a first power 20 through the constant voltage circuit 124.

Referring to FIG. 2, the rectifier 12 is coupled to the first DC/DC converter 11 for outputting the first power 20 to the first DC/DC converter 11. Moreover, the first power 20 is set to be a second power 22 through the first DC/DC converter 11, and the second power 22 supplies the motherboard of the computer with DC 5V, DC 12V and DC 3.3V.

Referring to FIG. 2, the rectifier 12 is coupled to the charger 14, and the first power 20 charges the rechargeable battery 16 through the charger 14.

When the wall-socket power fails, the detecting circuit 18 transmits a disconnection signal to drive the first DC/DC converter 11 and the DC/AC converter 15. At the same time, the rechargeable battery 16 supplies power to the first DC/DC converter 11 and the DC/AC converter 15.

When the wall-socket experiences a power failure, the DC power of the rechargeable battery 16 is set to be a second power 22 through the first DC/DC converter 11, and the second power 22 supplies the motherboard of the computer with DC 5V, DC 12V and DC 3.3V.

During a wall-socket power failure, the DC power of the rechargeable battery 16 is converted to AC power 26 through the DC/AC converter 15, and an AC output port 32 receives the AC power 26 to supply the computer display and peripheral devices with frequently used levels of AC 110V and AC 220V. The computer display is, for example, an AC display and cathode ray tube (CRT) display.

Referring to FIG. 2, a second DC/DC converter 13 is coupled to the detector 18 and the rechargeable battery 16. During a wall-socket power failure, the detecting circuit 18 transmits a disconnect signal to the second DC/DC converter 13 to drive the second DC/DC converter 13. Moreover the second DC/DC converter 13 boosts the rechargeable battery 16 to a third power 24. The third power 24 supplies DC device DC power of frequently used levels DC 12V, 16V, 18V and 24V when wall-socket power fails. The DC device is, for example, a DC display and liquid crystal display (LCD).

When the wall-socket power fails, the first DC/DC converter 11, the second DC/DC converter 13 and the DC/AC converter 15 separately convert the power of the rechargeable battery 16 to the second power 22, the third power 24 and the AC power 26, and supply power to the motherboard and peripheral devices requiring DC/AC power.

Therefore the present invention supplies power to the motherboard, DC peripheral device and AC peripheral device by the rechargeable battery 16 when wall-socket power fails so as to process and store the data on processing.

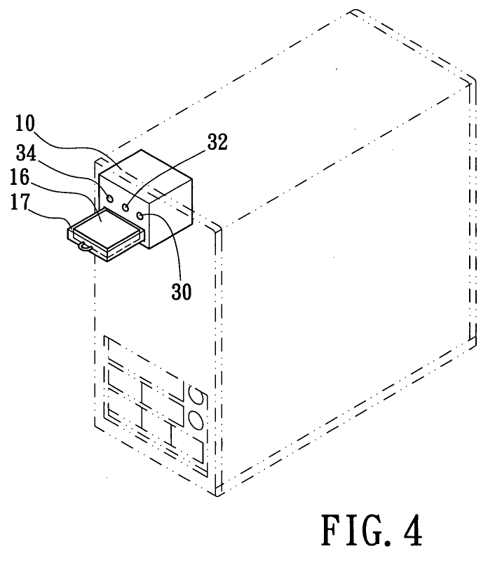

FIG. 4 is a perspective view of the present invention, in which the rechargeable battery 16 fits in a portable box 17, and the portable box 17 is coupled to the charger 14 with an electrical contact for forming a portable rechargeable battery. Therefore a battery is easily maintained and changed when the rechargeable battery 16 is broken.

The features of the present invention are listed as follows:

(1) Power is provided during wall-socket power failure.

(2) The invention is compact in size, cheap and simple with regard to circuits.

(3) AC power and DC power of frequently used levels is provided.

(4) A portable rechargeable battery is provided to simplify, maintain and change tasks.

Therefore the present invention improves upon the prior art power supply with a built-in UPS. Moreover the present invention supplies power to the DC/AC peripheral device and the rechargeable battery is easy to maintain and change.

Those skilled in the art will readily observe that numerous modifications and alterations of the device may be made while retaining the teachings of the invention. Accordingly, the above disclosure should be construed as limited only by the metes and bounds of the appended claims.

1. A power supply with AC/DC back-up power for a computer, comprising:
a rectifier connected to a wall-socket for generating a first power;
a rechargeable battery;
a charger connected to the rectifier and the rechargeable battery and charging the rechargeable battery with the first power;
a detecting circuit connected to the wallsocket and detecting a power-supplying condition of the wall-socket;
a first DC/DC converter connected to the rectifier, the detecting circuit and the rechargeable battery, and used to convert a power of one of the battery and the first power to a second power supplied to a motherboard; and
a DC/AC converter connected to the rechargeable battery and the detecting circuit, and converting a power of the battery into AC power.

2. The power supply of claim 1, wherein the rectifier further comprises:
an EMI filter for filtering out noise of power in the wall-socket;
a bridge rectifier coupled to the EMI filter for converting wall-socket power into a: DC power; and
a constant voltage circuit coupled to the bridge rectifier for stabilizing the DC power to be the first power.

3. The power supply of claim 1, wherein the rechargeable battery is fit in a portable box, and the portable box is coupled to the charger with an electrical contact to form a portable rechargeable battery.

4. The power supply of claim 1, wherein the second power includes DC 5V, DC 12V and DC 3.3V.

5. The power supply, of claim 1, wherein the AC power supplies power to an AC display.

6. The power supply of claim 5, wherein the AC display is a cathode ray tube (CRT) display.

7. The power supply of claim 1, further comprising a second DC/DC converter connected to the rechargeable battery and the detecting circuit for converting the power of the rechargeable battery to a third power.

8. The power supply of claim 7, wherein the third power includes DC 12V, DC 16V, DC 18V and DC 24V.

9. The power supply of claim 8, wherein the third power supplies power to a DC display.

10. The power supply of claim 9, wherein the DC display is a liquid crystal display (LCD).

11. The power supply of claim 7, further comprising:
an AC input port coupled to the power of the wall-socket;
a DC output port coupled to the third power for connecting the DC peripheral device; and
an AC output port coupled to the AC power for connecting the AC peripheral device.
